(19) United States
(12) Patent Application Publication
(10) Pub. No.: US 2021/0097404 A1
(43) Pub. Date: Apr. 1, 2021

(54) SYSTEMS AND METHODS FOR CREATING PRODUCT CLASSIFICATION TAXONOMIES USING UNIVERSAL PRODUCT CLASSIFICATION ONTOLOGIES

(71) Applicant: KPMG LLP, New York, NY (US)

(72) Inventors: John A. YANOSY, JR., Grapevine, TX (US); Anuj KHANNA, New York, NY (US)

(21) Appl. No.: 16/584,498

(22) Filed: Sep. 26, 2019

(51) Int. Cl. G06N 5/02; G06N 5/04

(52) U.S. Cl. CPC G06N 5/02; G06N 5/04

(57) ABSTRACT

Systems and methods disclosed herein provide for creating product classification taxonomies using universal product classification ontologies, as well as the version-managing thereof. Embodiments of the systems and methods enable the creation of human and computer interpretable, self-consistent, and global semantic knowledge structures covering multiple product domains, each organized as a hierarchical taxonomy of explicit and unambiguous product definitions. Embodiments of the systems and methods also provide for user interfaces for classifying unknown products using the universal product classification ontologies.

### FIELD OF THE INVENTION

The present invention relates generally to information and computer science, and more particularly to systems and methods for creating product classification taxonomies using universal product classification ontologies, as well as the version-managing thereof.

### BACKGROUND

Many products, goods, and services are categorized or classified by taxonomic concepts, which can have parent-child relationships that typically proceed from general product categories to more-specialized product categories in a branching downward tree-like structure from a single major category root. Some classification application environments have multiple classification taxonomies representing hierarchical classification structures in different domains. For each classification taxonomy, each taxonomic level and classification class must satisfy the defining characteristics of its direct parent level classification class while simultaneously defining some unique characteristics, not defined at the parent level, which this child classification class must satisfy. When there are sibling classification classes at the same taxonomic level, and when the sibling classification classes have the same parent classification class, their classification definitions specify additional conditions that members of the parent class have to satisfy to be members of this specific child classification class, and of which some subset of classification characteristics are different. Each sibling classification class in this case has some subset of their own unique set of characteristics that differentiate between them at this taxonomic level, but also maintain the requirement that their members satisfy the common parent classification class definitions, and may also have some common classification characteristics between them. Each product classification definition at each level in the classification hierarchy will then have a set of characteristics that are defined at its level but also dependent on the set of definitions of a connected set of parent-child relationships in some connected path (e.g., a connected set of parent-child classification classes) of classification definition classes, starting from the root product definition, down through each directly taxonomic connected child classification class, to its product classification level. At this taxonomic level and classification class, the product has been classified according to the connected taxonomic classification class path in the taxonomy model and is fully classified by the final child class in and its connected path.

In some application situations, there may be more than one taxonomy covering a major domain of product types, each having their own domain vocabulary, set of classification classes associated with their domain vocabulary, and their own taxonomic semantic relation structure. Further, some product classifications may not follow a strict sub sumptive reasoning general-to-specific product taxonomy; in these cases, the category of product can be further associated with some other property such as department or geographical region in another taxonomy or within the same taxonomy. In order to properly classify a product, it is important to understand the meaning of the corresponding product descriptions and its hierarchical relationship to its parents and children definitions, i.e., its location in the product classification taxonomy. Once the meaning is understood, only then can ontology reasoning occur to determine which, if any, product classification definition in the taxonomy a particular product satisfies. Generally, product classification definitions use natural language to convey meaning in original source documents. However, using natural language can lead to ambiguity. Further, ambiguous classification can lead to lost revenue and/or inflated costs (e.g., errors due to misclassification).

Current systems involve multiple product classifications structures and definitions typically offered in a variety of formats, e.g., structured documents, spreadsheets, databases, with no easy way to discover and navigate through product computer-interpretable definitions and discoverable product-category relationships. Specifically, even though structured source information (e.g., tables or information structured by relational database schemas) or source information having associated metadata tags may be provided to facilitate the understanding of the taxonomic relational structure, they can still be ambiguous since there is typically no specific semantic information that a computer could interpret that explicitly defines the taxonomic hierarchical sematic relationships between parent and child product classification definitions.

Further, current systems also rely heavily on human involvement in the disambiguation process, leading to inefficiencies and error.

It would be desirable, therefore, to have systems and methods that could overcome these and other deficiencies described above.

### SUMMARY

According to an embodiment, the present invention relates to a system and method for creating product classification taxonomies using universal product classification ontologies, as well as the version-managing thereof.

According to an embodiment, a system for creating a product classification taxonomy for an existing product taxonomy using a universal product classification ontology can include: (a) at least one processing module comprising at least one computer processor and at least one electronic memory, wherein the at least one processing module is programmed to create the product classification taxonomy by: (i) asserting a plurality of subclasses for a plurality of entity terms in the existing product taxonomy as subclasses of classes defined in the universal product classification ontology, (ii) generating semantic relationships between the plurality of entity terms asserted as subclasses using predefined semantic relationships from the universal product classification ontology, and (iii) generating a combination of the semantic relationships to create a product classification definition in the product classification taxonomy based on the universal product classification ontology for at least one definition associated with the plurality of entity terms in the existing product taxonomy; and (b) a reasoning engine comprising a computer processor that is programmed to validate the product classification definition.

Further, according to an embodiment, a computer-implemented system for creating a new product classification taxonomy based on an existing product classification taxonomy using a universal product classification ontology can include at least one computer processor and an electronic memory, wherein the least one computer processor is programmed to create the new product classification taxonomy by: (i) determining which changes were made to the existing product classification taxonomy, (ii) editing domain vocabulary terms associated with the existing product classification taxonomy corresponding to the changes, (iii) editing at least one of an asserted class relation and an asserted subclass relation for at least one universal product classification ontology class in the existing product classification taxonomy based on the changes, (iv) editing at least one asserted semantic relationship in the existing product classification taxonomy based on the changes, and (v) editing at least one combined semantic relationship based on the changes, and wherein the least one computer processor is further programmed to validate the created new product classification taxonomy.

According to an embodiment, the present invention also relates to computer-implemented systems and methods for classifying unknown products using the universal product classification ontologies. For example, a computer-implemented method for classifying unknown products using a universal product classification ontology can include: receiving, with a user interface, product information text associated with the unknown product; determining, with a computer processor, semantic relationship expressions associated with the product information text using the universal product classification ontology; classifying, with the computer processor, the unknown product with at least one product classification definition based on the determined semantic relationship expressions; and displaying, with the user interface, at least one product code or other classification identifier associated with the at least one product classification definition.

According to an embodiment, the present invention can be applied towards the domain of product classification within a taxonomic hierarchical structure as well as other domains of classification in which the things being classified are not products that are offered for sale or manufactured, but other kinds of things which benefit from taxonomic classification, e.g., taxonomic classification of books in library systems as in the Dewey Decimal System, organizations using asset taxonomies for taxing and financial purposes, medical taxonomies for medicines for regulatory and medical protocol purposes, etc. In addition, the present invention also supports hybrid classification structures that are not pure taxonomies, but rather structures that group things by similar and dissimilar characteristics for classification purposes, as well as potentially having taxonomies within some classification groupings. These latter non-taxonomic classification structures may have defined relationships between classification groupings and between members in these groupings that provide additional classification value, such as part/whole relations, or disjoint relations, or dependency relations. These non-taxonomic semantic relationships can be defined in the current invention to assist in the classification reasoning, such as disjoint relation defining that a member of a classification group cannot simultaneously be a member of another group, or a part/whole relationship defining that a member in one group depends on another member in another classification group for its function or other characteristic. As such, the present invention enables the creation of semantic definitions for classification and automatic classification reasoning for any hybrid classification structure and different kinds of semantic relationships between classes/groups of things.

Furthermore, the version knowledge system is based on a modular version management ontology that represents knowledge about all version-managed entities, which can include: (i) changes that occur within the core ontology itself (e.g., editing of any existing ontology classes, deprecation or addition of any ontology classification classes), (ii) the addition of a new ontology classification class, (iii) modifications of the extended domain-specific ontology (e.g., editing of the existing domain vocabulary and their asserted subclass and base-level semantic relationships (e.g., “atomic-level” relationships), the editing of the combined atomic-level relationships (e.g., “complex” classification patterns) that define the necessary and sufficient conditions for satisfying classification reasoning), (iv) the deprecation of existing domain classification ontology classes, or the addition of new domain classification ontology classes.

Furthermore, the version knowledge system ontology can enable the discovery of the latest version of any managed entity and also represent the effects of changes on the classification reasoning dependencies within the ontology.

According to an embodiment, the systems and methods enable the creation of a human and computer interpretable, self-consistent, and global semantic knowledge structure covering multiple product domains, each organized as a hierarchical taxonomy of explicit and unambiguous product definitions. The systems and methods may replace the definitional natural language (text) ambiguity contained in the current systems with a consistent, testable, ontological set of hierarchical taxonomic product classification definitions.

Further, the systems and methods also provide for global unique product definitions based on a universal common set of atomic-level ontology metadata expressions proscribed within a universal product classification ontology that can be specialized with specific domain concepts and vocabulary terms. This approach uniquely enables knowledge reasoning and representation system design to be domain-independent, but yet simultaneously re-purposable by specializing the universal product classification ontology to the domain concepts and vocabulary used for taxonomic definitions. The universal product classification ontology is sufficient to represent accurately any domain entity type definition and its taxonomic hierarchical relationship to other definitions, while also providing the advantage of clearly and unambiguously constraining the kind and amount of information required to accurately disambiguate these hierarchical taxonomic definitions from each other.

Further, the systems and methods provide for explicit and explanatory descriptions of all of the product classifications for unknown product descriptions that need to be classified consistent with a particular product taxonomy in a document. Specifically, the system can fully represent each product definition in a combined human and machine-understandable language (and models), which enables human review for accuracy and completeness. According to an embodiment, the product definitions can be structured in complex hierarchical parent-child tree structures, where the ontology architecture and language used is sufficiently understandable to represent the individual product definitions using the original product vocabulary. Further, the ontology knowledge architecture has the advantage of representing understandable definitions using the vocabulary of the product document while simultaneously using an upper ontology to be able to cover wide variety of product domains, from agriculture, to drugs, to electronic components, to complex systems and many more. In addition, the system also provides the ability to the user to select which product descriptions to classify but to also see all of the full and partial entailments in great detail, which current systems cannot do.

Further, assuming an unknown product has its atomic-level characteristic expressed using the ontology domain vocabulary and the atomic-level ontology patterns, the system can also provide partial and full entailment results of product classification in a taxonomy. These results can be displayed with a user interface. According to an embodiment, the user interface can create a SPARQL query to find the partial and full entailment reasoning results and then render them appropriately to the user through the interface display.

According to an embodiment, the SPARQL queries can be made using any number of atomic-level expressions that have been asserted for the unknown product to be classified, for the purpose of finding all of the ontology domain product classes containing this specific combination of atomic-level patterns.

Further, with regard to partial entailments, the user interface also provides an ability for the user to see which additional information would be necessary to fully entail any of the partial product classification.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1A illustrates product classification definitions organized in a taxonomic hierarchical structure table for the Harmonized Tariff Schedule (HTS) as managed by the U.S. International Trade Commission according to an exemplary embodiment of the invention.

FIG. 1B illustrates a classification hierarchy diagram of the product classification definitions illustrated in FIG. 1A according to an exemplary embodiment of the invention.

FIG. 2A illustrates a metadata language stack used to create a universal product classification ontology according to an exemplary embodiment of the invention.

FIG. 2B illustrates an assertion of an atomic-level pattern expression according to an exemplary embodiment of the invention.

FIG. 2C illustrates an assertion of another atomic-level pattern expression according to an exemplary embodiment of the invention.

FIG. 2D illustrates a diagram applying multiple atomic-level patterns to the product classification definition in FIG. 1A according to an exemplary embodiment of the invention.

FIG. 3 illustrates a domain-independent product classification knowledge system according to an exemplary embodiment of the invention.

FIG. 4A illustrates a creation process flow for a domain-independent product classification knowledge system according to an exemplary embodiment of the invention.

FIG. 4B illustrates a version management process flow for a domain-independent product classification knowledge system according to an exemplary embodiment of the invention.

FIG. 5A illustrates a user interface sequence process flow for classifying unknown products according to an exemplary embodiment of the invention.

FIG. 5B illustrates the initial steps of the sequence process flow of FIG. 5A according to an exemplary embodiment of the invention.

FIG. 5C illustrates the final steps of the sequence process flow of FIG. 5A according to an exemplary embodiment of the invention.

FIG. 6A illustrates another user interface sequence process flow for classifying unknown products according to an exemplary embodiment of the invention.

FIG. 6B illustrates the first step of the sequence process flow of FIG. 6A according to an exemplary embodiment of the invention.

FIG. 6C illustrates the second step of the sequence process flow of FIG. 6A according to an exemplary embodiment of the invention.

FIG. 6D illustrates the third step of the sequence process flow of FIG. 6A according to an exemplary embodiment of the invention.

FIG. 6E illustrates the fourth step of the sequence process flow of FIG. 6A according to an exemplary embodiment of the invention.

FIG. 6F illustrates the fifth step of the sequence process flow of FIG. 6A according to an exemplary embodiment of the invention.

FIG. 7 illustrates an exemplary set of atomic-level expressions and their respective domain and range universal product classification ontology classes for each universal product classification ontology relation.

### DETAILED DESCRIPTION OF EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. Though the examples provided in this application describe classification taxonomies for products in the tariff domain, the invention can be applied to any hierarchical classification taxonomy for any kind of entity in any domain. Examples of other kinds of classification taxonomies include: offered services classification taxonomies, supply chain classification taxonomies, medical equipment taxonomies, business type classification taxonomies, etc.

A taxonomy can be described using a table or a diagram structure where the taxonomic parent-child relationships in the table are indicated by indenting the child definition from the parent definition and, in the diagram structure, can be rendered by directed arrows between the parent and child classifications. Other forms of representing the taxonomic structures are possible, including: XML Schemas defining the parent-child relationships, structured labeled graphs, rdf-linked data graphs, and alphanumeric codes where the structure of the code indicates whether the code associated with a classification definition has a parent code classification and where other codes have a child relationship to this code.

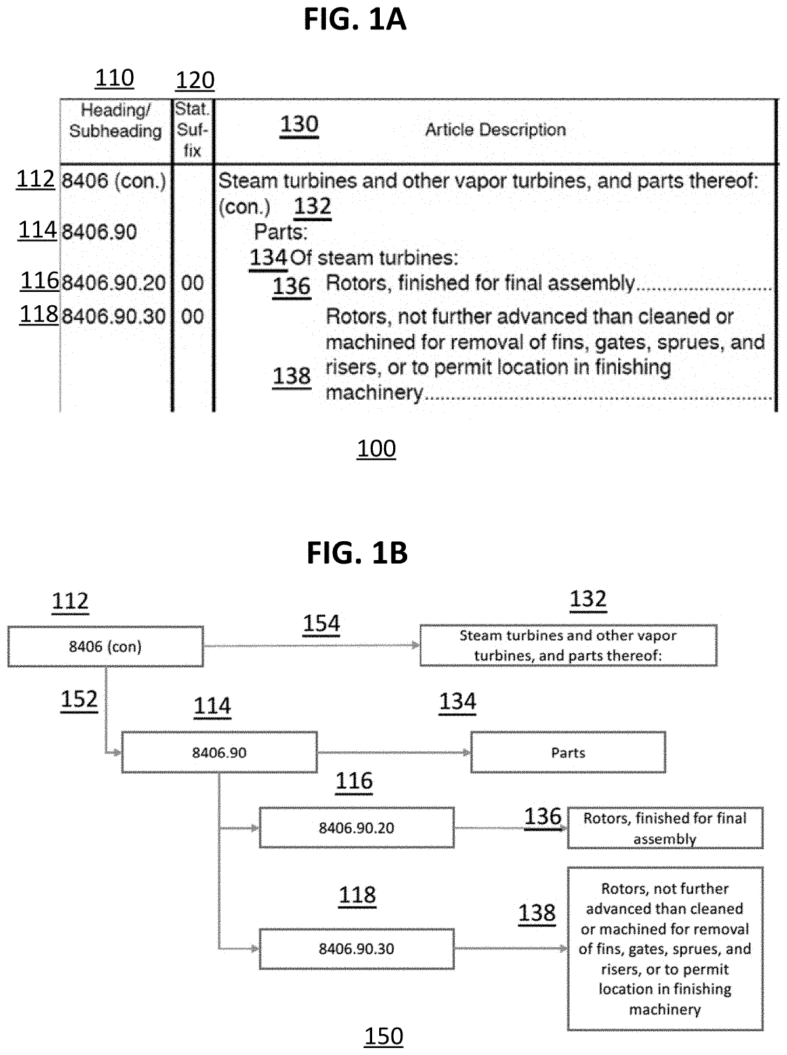

FIG. 1A illustrates the product classification definitions organized in a taxonomic hierarchical structure table for the HTS according to an exemplary embodiment of the invention. As depicted in the figure, table 100 includes a headings/subheadings column 110 with the codes for each level of the product taxonomy level, e.g., levels 112, 114, 116, and 118. Further, column 120 provides a potential 2-digit extension, i.e., a suffix, to each code in column 110. Column 130, i.e., “Article Description,” and its contents are exactly matched to the HTS product codes in the heading/subheading column 110. For example, product 112, having a code “8406 (con),” has an exact associated text-based product description 132, i.e., “Steam turbines and other vapor turbines, and parts thereof” Further, product 114, having a code “8406.90,” is a specialized kind of a product, i.e., “Parts,” which is described in its parent code 8406. In other words, the headings and sub-headings are represented with parent-child relationships that proceed from general product categories (e.g., 8406—steam turbines and other vapor turbines, and parts thereof) to more-specialized product categories (e.g., 8406.90.20—rotors, finished for assembly) in a branching downward tree-like structure.

FIG. 1B illustrates a classification hierarchy diagram of the product classification definitions illustrated in FIG. 1A according to an exemplary embodiment of the invention. As depicted in the figure, diagram 150 contains the same information as described in the table 100 of FIG. 1A, but presented in a labeled-graph format. For example, a taxonomic parent-child relationship can be represented with a directed arrow 152 from the parent product 112, i.e., code “8406”, to its child product 114, i.e., code “8406.90.” Further, the diagram can also represent the relationship between a product identifier and its definition. For example, a directed arrow 154 represents the relationship between the product identifier 112 and its text-based description 132.

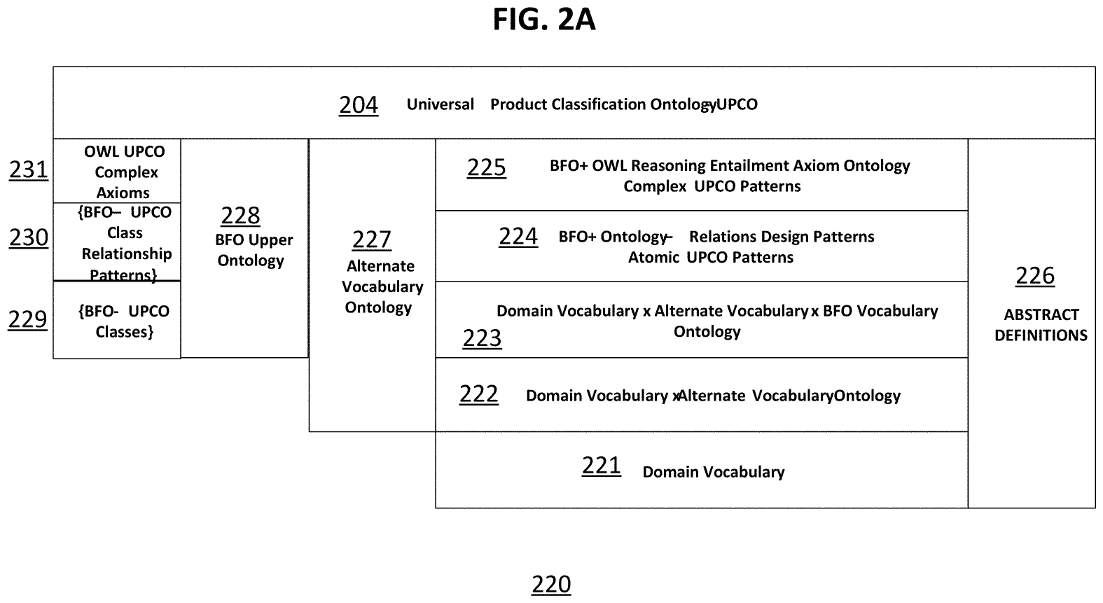

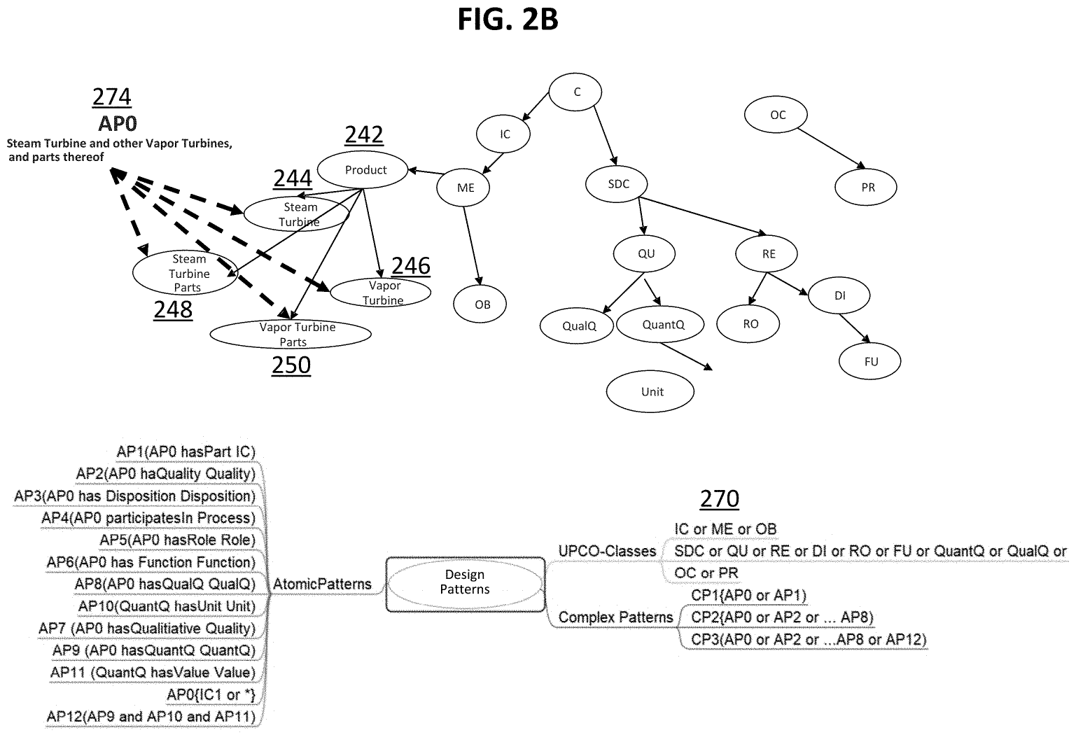

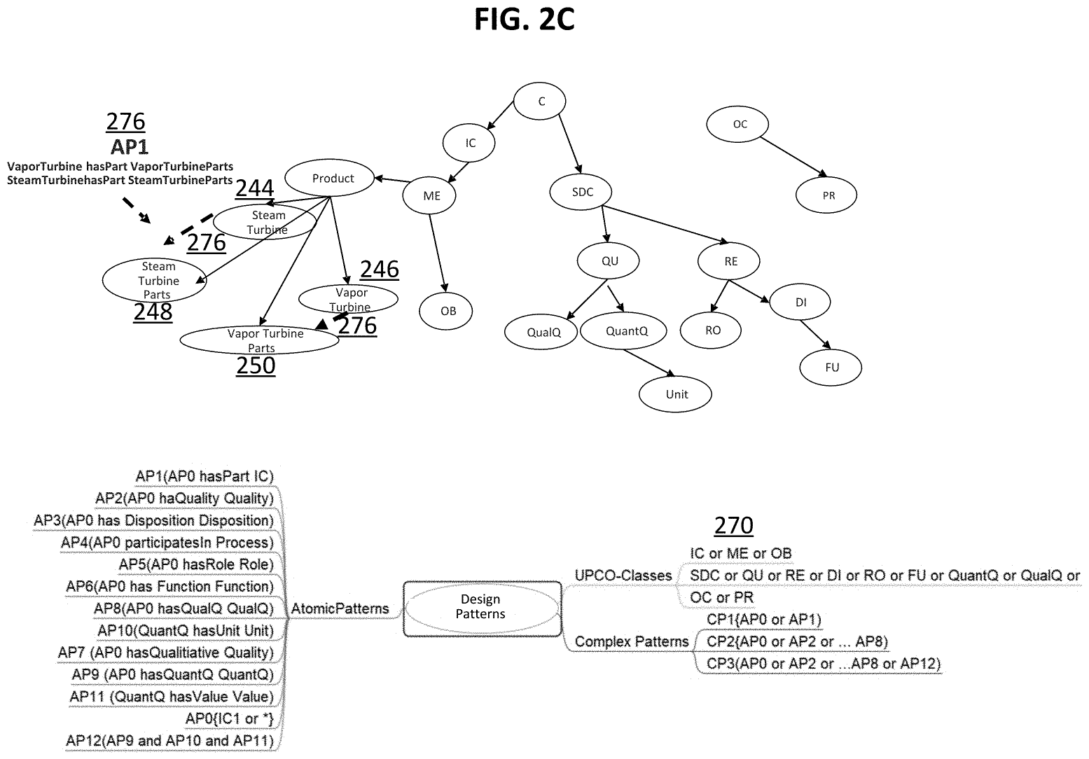

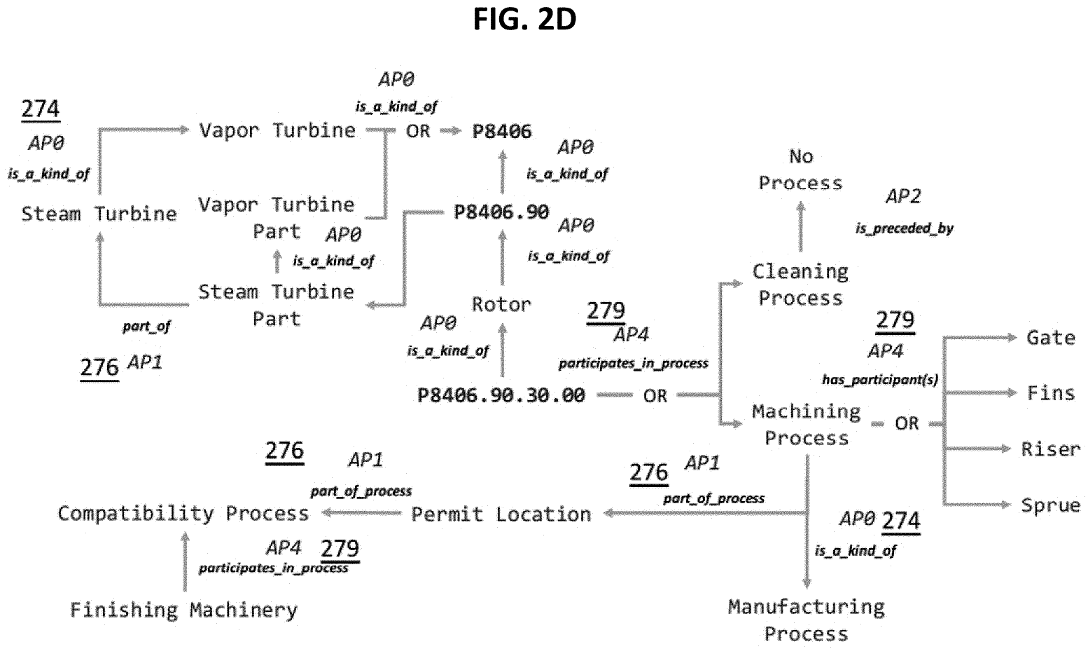

FIG. 2A illustrates a metadata language stack used to create a universal product classification ontology (UPCO) according to an exemplary embodiment of the invention. As depicted in the figure, diagram 220 includes a domain vocabulary metadata layer 221. According to an embodiment, the domain vocabulary metadata layer 221 includes the terms and concepts derived from information sources, typically documents, that describe and define the kinds of articles to be classified and the terms used in their classification definitions. For example, with regard to the HTS, there are approximately 96 different domains and taxonomies, each having their own domain vocabulary. Further, according to an embodiment, the terms of a domain vocabulary, once identified and extracted, can also be extended with alternate labels, such as synonyms from other ontologies 227, e.g., WordNet. The extension of domain vocabulary metadata layer 221 with synonyms from the alternate vocabulary ontology 227 creates an extended metadata layer 222. According to an embodiment, the extended domain vocabulary metadata layer 222 can enhance the semantic matching used during classification of unknown products. Further, a metadata layer 223 can be created by associating each term in the extended domain vocabulary metadata layer 222 with a select set of upper ontology classes defined in the publicly-available basic formal ontology (BFO) 228. In particular, after associating the term with one of the BFO classes, it is then asserted a new UPCO class, which is asserted as a subclass of the matched BFO class, thereby creating metadata layer 223. Further, a predefined set of atomic-level ontology patterns 230 (see FIG. 2B), or relation patterns, consisting of the BFO classes 229, can then be used to interpret the text of product classification definitions. According to an embodiment, each atomic-level pattern has the following structure: (UPCO-BFO-Class UPCO-BFOProperty UPCO-BFO-Class). The set of UPCO-BFO-Classes selected for each pattern are based on the BFO upper ontology with some new extended UPCO classes, such as Product, QuantifiedQuality, QualifiedQuality, ProductFunction, etc. The interpretation of the product classification text first can involve the extraction and subclassing of the domain vocabulary terms as created in metadata layer 223. Then, each product classification text definition is examined to discover equivalent atomic-level patterns in which two domain vocabulary terms are related in the classification text definition. If two domain vocabulary terms are related in the text classification definition, then their corresponding parent UPCO-BFO class are matched with the atomic-level patterns, resulting in a new UPCO ontology assertion being created in metadata layer 224. According to an embodiment, because many text classification definitions may have the same atomic-level pattern assertions as components, the UPCO system can retain knowledge of which text classification definition the particular atomic-level pattern is associated with, which is important for the construction of the next metadata layer, i.e., layer 225. The metadata layer 225 represents the set of complex pattern assertions 231 for each article text classification definition through the logical sematic assembly of each atomic-level pattern in metadata layer 224.

FIG. 2B illustrates an assertion of a particular type of atomic-level pattern according to an exemplary embodiment of the invention. As depicted in the figure, in addition to upper BFO classes, the diagram also includes UPCO class extensions, such as Product 242, QuantQ, QualQ, and Unit. Atomic-level patterns AP0 to AP12 are universal type ontology design patterns representing the different relationships between the classes/subclasses in the UPCO. For example, atomic-level pattern expression AP0 (i.e., {IC1 or *}) defines the list of independent continuants (the term “independent continuants” generally refers to entities that can exist by themselves or part of other entities) or their children classes using vocabulary terms from the domain in which a taxonomy is being defined. As such, product vocabulary terms such as “SteamTurbine,” “VaporTurbine,” “SteamTurbineParts,” and “VaporTurbineParts” can be defined as subclasses for subclass “Product,” or AP0={Product, SteamTurbine, VaporTurbine, SteamTurbineParts, VaporTurbineParts}. In other words, the domain vocabulary terms SteamTurbine 244, VaporTurbine 246, SteamTurbineParts 248, and VaporTurbineParts 250 can be asserted as classes of the UPCO ontology and subclasses of the UPCO-BFO class product 242 using AP0 (i.e., element 274). This illustrates how the domain vocabulary terms can be subclassed to UPCO-BFO classes in metadata layer 223 of FIG. 2A. According to an embodiment, the atomic-level patterns AP0 to AP12 may be combined into complex patterns, e.g., CP1 to CP3. The following table clarifies the definition of each atomic-level pattern when they are asserted to create new domain-specific taxonomies and product classification definitions.

| Atomic | | |
|---|---|---|
| Pattern | | |
| Identifier | Universal Expressions | Definition |
| AP0 | {IC1 or *} | Defines that one or more domain vocabulary terms are |
| | | subclasses of one of the independent continuant UPCO-BFO |
| | | classes, such as Product. |
| | | Example: {Product, SteamTurbine, VaporTurbine}. |
| AP1 | {AP0 hasPart IC} | Asserts that a class defined in AP0 has a property, “hasPart” |
| | | with another subclass of the independent continuant class, |
| | | typically Product in this example. |
| | | Example: {SteamTurbine hasPart SteamTurbineParts}, |
| | | {VaporTurbine hasPart VaporTurbineParts). |
| | | AP1 can also be used to define hasPart relationships between |
| | | the classes of Processes. |
| AP2 | {AP0 hasQuality | Asserts that a domain class defined in AP0 has a defining |
| | Quality} | property “hasQuality” with the BFO class Quality or one of |
| | | its UPCO-BFO subclasses, such as QualQ or QuantQ, which |
| | | represent Qualitative Quality or Quantitative Quality, |
| | | respectively. |
| | | Example: {SteamTurbine hasQualQ Steam}. |
| | | In this example, the domain vocabulary term SteamTurbine |
| | | has already been subclassed to Product, and Steam has been |
| | | subclassed to QualQ, which is a subclass of BFO Quality. |
| | | This is a situation where the domain vocabulary term Steam is |
| | | used as a describing quality of the nature of the design of a |
| | | Turbine. Steam is also a BFO Material Entity with an |
| | | Independent Continuant existence, though not a Product in the |
| | | tariff definitional sense. |
| AP3 | {AP0 hasDisposition | Asserts that a domain class defined in AP0 has an inherent |
| | Disposition} | disposition represented by an assertion of the property |
| | | “hasDisposition” between the domain vocabulary class in |
| | | AP0 with another domain vocabulary class subclassed to BFO |
| | | Disposition. |
| | | Example: {SteamTurbine hasDisposition |
| | | EnergyConsumption), where EnergyConsumption is a |
| | | universal concept subclassed to Disposition for use in many |
| | | article definitions that consume energy to realize their function. |
| AP4 | {AP0 participatesIn | Asserts that a domain class defined in AP0 participates in a |
| | Process} | process which is usually another domain vocabulary term that |
| | | has been subclassed to the BFO class Process, such as |
| | | ProductProcess. |
| | | Example: {SteamTurbine participatesIn |
| | | ThermalEnergyExtraction}, where a SteamTurbine has been |
| | | asserted by definition as participating in a process to extract |
| | | thermal energy from Steam |
| AP5 | {AP0 hasRole Role} | Asserts that a domain class defined in AP0 has a defining role |
| | | expressed through the property “hasRole” with another BFO |
| | | class Role, which in the HTS example is specialized as |
| | | ProductRole. This can been subclassed with another UPCO |
| | | class ProductRole. |
| | | Example: {SteamTurbine hasRole EnergyTransformer}, |
| | | where any Steam Turbine can be viewed as transforming |
| | | energy in one form to another form which is useful for its |
| | | application. |
| AP6 | {AP0 hasFunction | Asserts that a domain class defined in AP0 has a function |
| | Function} | expressed through the property “hasFunction” with another |
| | | BFO class Function. This can been subclassed by a UPCO |
| | | class ProductFunction. |
| | | Example: {SteamTurbine hasFunction |
| | | CreateMechanicalWork} where CreateMechanicalWork is the |
| | | function of the Steam Turbine and is asserted as a subclass of |
| | | UPCO ProductFunction which is a subclass of BFO Function. |
| AP7 | {AP0 hasQualitative | Asserts that a domain class defined in BFO has a Qualitative |
| | Quality} | Quality using property “hasQualQ”. See AP2 for example. |
| AP8 | {AP0 hasQualQ | Same as AP7 but different property name. |
| | QualQ} | |
| AP9, | {AP0 hasQuantQ | Asserts that a domain class defined in AP0 has a quantitative |
| AP10, | QuantQ} | quality QuantQ through the property “hasQuantQ”. QuantQ is |
| AP11, | | a UPCO subclass of BFO class Quality. |
| Ap12 | | Ex: {SteamTurbine hasQuantQ 95 HP}, where 95 HP is a |
| | | Quantitative Quality which requires two additional properties |
| | | to define, AP10 (QuantQ hasUnit Unit} and {QuantQ |
| | | hasValue Value. |
| | | Ex: {95 HP hasValue 95}, {95 HP hasUnit HP}. |

The complex patterns CP1, CP2 or CP3 are combinations of the above atomic-level patterns that are used to create the final UPCO taxonomy classification definition for a Product in this exemplary use for HTS. This complex pattern is the OWL ontology expression defining necessary and sufficient conditions for membership in that product class.

FIG. 2C illustrates an assertion of another atomic-level pattern expression according to an exemplary embodiment of the invention. In particular, the figure illustrates the assertion of atomic-level pattern expression AP1, i.e., AP0 has Part Product. The atomic-level pattern expression AP1 defines that an independent continuant or its children has a part Product. For example, as depicted in the figure, “SteamTurbineParts” can be classified as a subclass of Product, which is a subclass of MaterialEntity, which is a subclass of IndependentContinuant. In the diagram the atomic-level pattern AP1 is applied between SteamTurbine 244 and SteamTurbineParts 248, and between VaporTurbine 246 and VaporTurbineParts 276. Similar directed arrows could be created for to represent UPCO assertions for each of the other atomic-level patterns between one of the Product classes and other UPCO classes, such as ProductFunction, QualQ, QuantQ, ProductDisposition, ProductRole, and ProductProcess using the appropriate atomic-level pattern.

FIG. 2D illustrates a diagram applying multiple atomic-level patterns to the product classification definition in FIG. 1A according to an exemplary embodiment of the invention.

For example, the taxonomic structure is defined by atomic-level pattern AP0 via the sequence of atomic-level patterns (P8406.90.30.00 AP0 Rotor), (Rotor AP0 P8406.90), and (P8406.90 AP0 P8406), where AP0 stands for the property “is_a_kind_of.” Additionally, as depicted in the figure, a “Vapor Turbine” or a “Vapor Turbine Part” is a kind of product associated with P8406, which is defined using atomic-level pattern AP0. Further, a “Steam Turbine Part” is a kind of a “Vapor Turbine Part” and is also part of a “Steam Turbine,” which is also a kind of “Vapor Turbine.” Further, product P8406.90.30.00 is a kind of rotor, which is a kind of product associated with product P8406.90, which is a kind of product associated with product P8406. In addition, product P8406.90.30.00 also participates in either a cleaning process AP4 or machining process, where (i) the cleaning process precedes no other process and (ii) the machining process has the following participants: gate, fins, risers, and sprues. Further, the machining process is a kind of manufacturing process and is part of the process to permit locations, which itself is part of a compatibility process that includes finishing machinery.

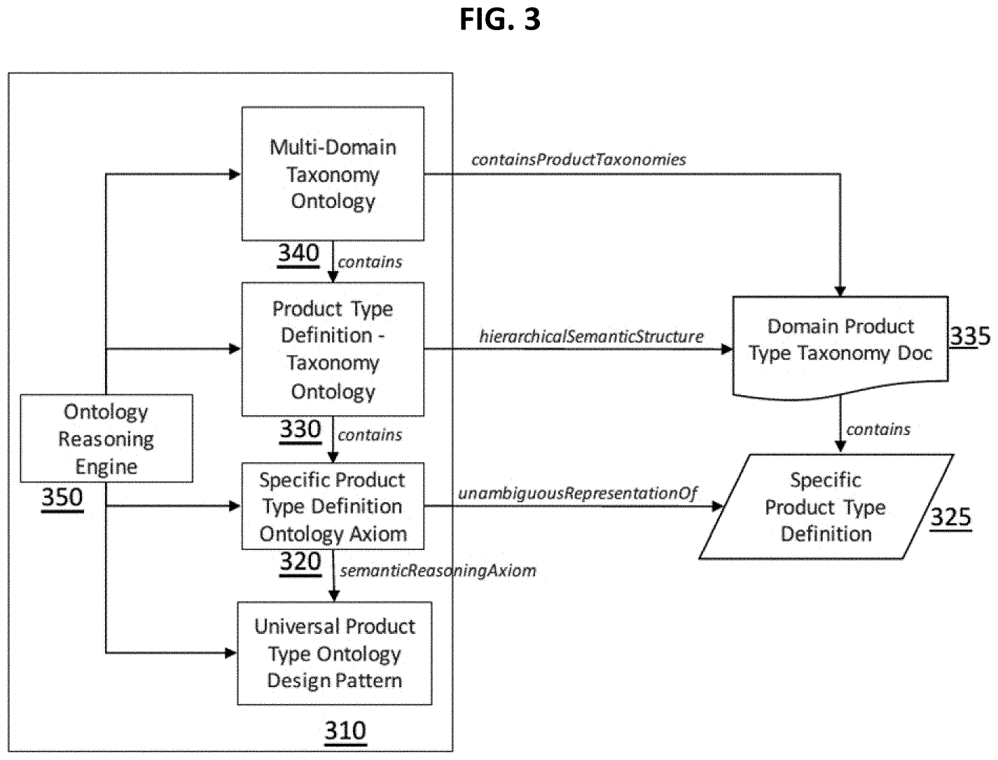

FIG. 3 illustrates a domain-independent product classification knowledge system according to an exemplary embodiment of the invention. According to an embodiment, a product classification knowledge system 300 includes a reasoning engine 350 that is configured to execute against the UPCO product classification ontologies and the complex patterns for the following inferences: (a) to validate that the classification definitions represent a unique product classification compared to all other product classifications; (b) that the structure is strictly taxonomic with parent-child relationships, where each classification definition has only one parent in the taxonomy, and (c) when atomic-level facts are asserted about an unknown product, the reasoning engine will associate the unknown product class with the correct classification parent in the product classification taxonomy.

According to an embodiment, the creation of the product classification taxonomy can be derived from the product information in a domain product type taxonomy document 335 and, in particular, the specific product type definitions 325 contained in the document 335, utilizing the UPCO 310. According to an embodiment, the reasoning engine is compliant with OWL 2 Web Ontology Language (“OWL2”). As depicted in the figure, the reasoning engine 350 can be utilized with any domain taxonomy ontologies 340 which can include a product type definition taxonomy ontology 330 associated with the domain product type taxonomy document 335. Specifically, the product type definition taxonomy ontology 330 is a hierarchical semantic representation of the taxonomy described in document 335. Further, according to an embodiment, each product type definition taxonomy ontology 330 can include a plurality of specific product type definition ontology axioms 320, which are an unambiguous representation of the specific type definitions 325 in the document 335 and are generated utilizing the semantic reasoning axioms of the universal product type ontology design patterns 310. According to an embodiment, each domain in the multiple domain taxonomy ontology 340 can be associated with a corresponding domain product type taxonomy document 335. For example, assuming the document 335 was associated with a chapter in the HTS, each domain in the multiple domain taxonomy ontology 340 can be associated with a different chapter in the HTS. As such, because there are multiple chapters in the HTS, multiple domain taxonomy ontology 340 can include at least the same number of multiple distinct domain specific product classification taxonomy ontologies. For example, the document 335 may be associated with chapter 84 of the Harmonized Tariff Schedule, i.e., “Nuclear reactors, boilers, machinery and mechanical appliances; parts thereof” Further, the specific type definitions 325 may correspond to one of the product definitions in chapter 84. For example, the specific type definitions may correspond to the article description for heading/subheading P8406, e.g., “steam turbines and other vapor turbines, and parts thereof.”

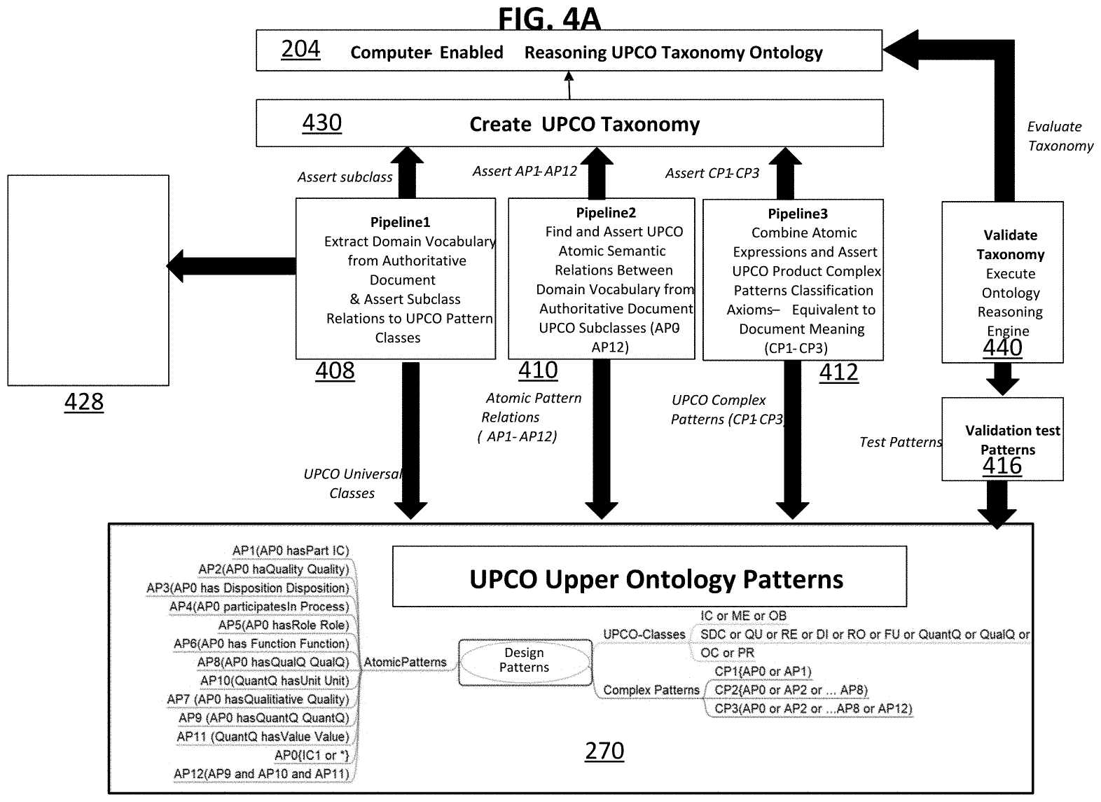

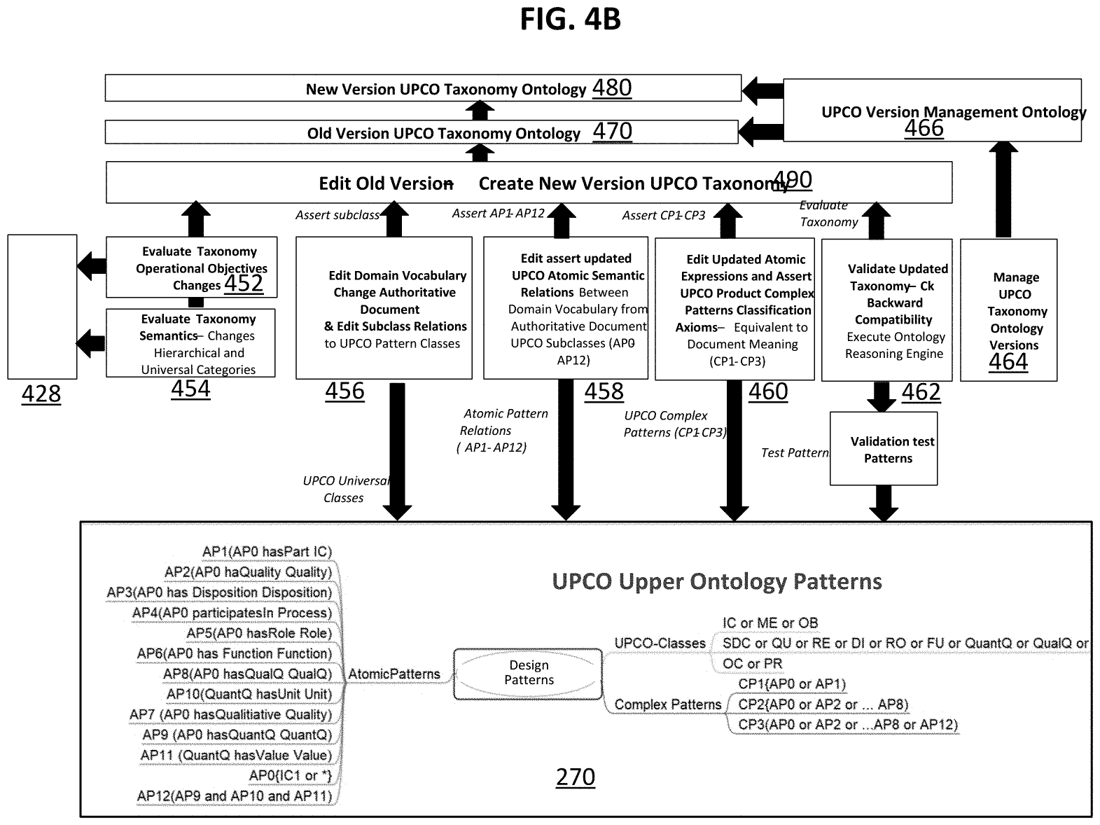

FIG. 4A illustrates a creation process flow for a domain-independent product classification knowledge system according to an exemplary embodiment of the invention. According to an embodiment, it becomes domain dependent when a particular domain product classification taxonomy 204 is created using the technology-implemented steps identified in the figure.

Specifically, the product classification knowledge system identifies those steps necessary to create a UPCO taxonomy 204 for the product taxonomy contained in the document 428, which describes product names as well as differentiating qualia in the taxonomy.

According to an embodiment, the UPCO can be created with the assistance of a plurality of processing modules (sometimes also referred to as “pipelines”) associated with the product classification knowledge system. As used herein, the term “processing module” generally refers to software and/or hardware including at least one computer processor and at least one electronic memory. Further, these modules can also include a natural-language-processing-based (NLP-based) technology combined with ontology editing tools which support OWL2 ontology development.

According to an embodiment, in a first processing module 408, (i) the NLP-based technology extracts all of the terms used in the product taxonomy in document 428, (ii) the UPCO domain vocabulary is populated with the extracted terms, and (iii) subclass relations are asserted for each of the domain vocabulary terms to at least one of the UPCO classes (e.g., independent continuant, material entity, specialized dependent continuant, quality, realizable entity, disposition, function, occurrent, process, etc.). According to an embodiment, the taxonomy structure for the UPCO is created using the OWL subclass relation between parent and child. As such, any subclasses at the child level can automatically satisfy any of the parent classes moving up the taxonomy hierarchy.

In a second processing module 410, atomic-level semantic relationships 270 can be found and asserted between the domain vocabulary terms asserted as subclass relations in the first processing module 408. According to an embodiment, the atomic-level relationships, e.g., AP1 to AP12, are based on the UPCO classes (e.g., independent continuant, material entity, product, specialized dependent continuant, quality, qualitative quality, quantitative quality, realizable entity, disposition, function, occurrent, process, etc.) as well as a set of binary relations between pairs of these classes defined in the atomic-level patterns AP0-AP12, e.g., “hasPart”, “hasQuality”, “hasDisposition”, “hasRole”, “hasFunction”, “hasQualQ”, “hasQuantQ”, “hasUnit”, “hasValue”, and “participatesInProcess.” According to an embodiment, machine learning can be implemented to identify the occurrence of the atomic-level patterns, where pairs of domain vocabulary terms can be related by their respective binary properties for each atomic-level pattern AP0-AP12 that occurs in the product classification definition text 428. Further, according to an embodiment, the product classification knowledge system can use a W3C OWL2 editing ontology tool to create/edit the atomic-level expressions AP1-AP12 in the second processing module 410 and in metadata layer 224 of FIG. 2A.

In a third processing module 412, the atomic-level pattern assertions from the second processing module 410 are combined in order to create the complex patterns e.g., CP1 to CP3, for each product classification definition in the product classification taxonomy. In particular, the complex pattern axioms are asserted for each class having a product classification definition in the domain-specific UPCO to represent the definitions in the product taxonomy in the document 428. For example, the meaning for class P8406 Steam Turbine can be created using the complex expression [(P8406 or SteamTurbine or VaporTurbine) and (SteamTurbine isA P8406) and (VaporTurbine isA P8406], which is a combination of two atomic-level expressions, i.e., “AP0 (SteamTurbine isA P8406) and AP0 (VTurbine isA P8406),” and includes the parent classes (P8406 or SteamTurbine or VaporTurbine) as the highest level in the product classification taxonomy hierarchy. According to an embodiment, the product classification knowledge system can use a W3C OWL2 ontology tool to create/edit the complex patterns in OWL2. In particular, the OWL2 ontology tool can create intentional meaning for reasoning using a complex OWL Class Equivalence expression based on the atomic-level expressions.

After the creation of the UPCO, the reasoning engine 350 of FIG. 3 executes step 440 using validation test patterns 416 to (a) test and validate the product classification structure and (b) validate each product classification class definition with its defining classification complex pattern. According to an embodiment, each product classification expression can have the following pattern (ParentClassName, CP1 or CP2 or CP3). The reasoning engine 350 can compare the created UPCO to a variety of test patterns. According to an embodiment, the test patterns can be predefined. With regard to the testing and validating of the product classification structure, after the reasoning engine 350 is executed, inferred results can be evaluated to ensure that each product classification class with a complex pattern has only one parent class in the taxonomy. This can be achieved by executing a SPARQL query against the inferred reasoning results to discover all of the product classification classes that have more than one parent class. If there is more than one parent class, an evaluation is performed comparing the desired taxonomy structure described in an authoritative document with the parent classes to determine which parent product classification class is correct and which classes are incorrect. At this point, the complex pattern of the failed product classification class is examined to ensure that the current parent class is identified in its complex pattern. With regard to the validation of each product classification class definition with its defining classification complex pattern, a product classification definition based on the complex pattern is tested first by examining the defining authoritative text to ensure that all possible atomic-level patterns derivable from the defining text have been created for this product classification. Then, a new test class is designed, where the same set of atomic-level patterns are asserted as an equivalence axiom in the test class and added to the knowledge base. According to an embodiment, executing the reasoning engine 350 can cause this test class to be automatically be inferred as a subclass of the product classification class having the same authoritative text definition. In this manner, every product classification class is tested with its own unique test class and, when the reasoning engine is executed, each test class can be asserted as a subclass of the appropriate product classification class.

Further, after the creation of the particular UPCO for the document 428, the product classification knowledge system can proceed with the creation of an UPCO taxonomy for another related document defining another domain product classification taxonomy. For example, assuming the document 428 corresponds to a chapter in the HTS, the other related document can correspond to another chapter. According to another embodiment, the creation of the UPCO for the document 428 and the other related document can occur concurrently. According to an embodiment, the domain-specific product classification taxonomies can be modularized as separate ontologies, where a larger separate integrated ontology can be created that imports each of the product classification ontologies. In this regard, the first, second, and third processing modules (i.e., 408, 410, and 412) as well as step 440 have to be performed for each of the separate product classification authoritative documents and corresponding taxonomies 204.

FIG. 4B illustrates a version management process flow for a domain-independent product classification knowledge system according to an exemplary embodiment of the invention. It is similar to FIG. 4A, except that the goal is to enable editing and version management of the individual domain-specific product classification taxonomies 470 and 480. In this regard, a product classification taxonomy editing and version management tool that incorporates the functionality identified by the steps in FIG. 4A can be provided. According to an embodiment, there is a continuous need to be able to modify the domain-independent UPCO and each domain-dependent UPCO taxonomy over time as changes occur. As such, a version management ontology can be defined and integrated with the UPCO, which can enable provenance knowledge to be asserted for each modified area in the UPCO, which then enables them to have metadata asserted for each ontology version. In particular, as depicted in the figure, in order to edit an older version 470 of a UPCO, a newer version 480 of the UPCO is created. According to an embodiment, the product classification knowledge system first determines what kind of changes are to be made to the UPCO in steps 452 and 454. Step 452 evaluates whether there has been any major change in the approach for classification by using a classification structure as a taxonomy. If not, then the next steps can proceed with the possibility of backwards compatibility. However, if the nature of the classification structure semantics changes than an entirely new creation process has to occur as defined in FIG. 4A.

Further, step 454 identifies those areas in the taxonomy structure that are modified by either: (a) the addition of a new product classification class in the taxonomy which extends its structure (which can enable backwards compatibility); (b) deprecation of an existing product classification class in the taxonomy which can prevent backwards compatibility since new products can be prevented from being classified with this deprecated class in taxonomy 480 (any children product classification classes of this deprecated class are also deprecated by inference since the taxonomy classification requires the entailment or satisfaction of all parent classification classes in the path to the root class of the taxonomy); or (c) the editing of the set of atomic-level patterns in the complex pattern defining the entailment requirements for an existing product classification class in the taxonomy (which can prevent backwards compatibility for that branch of the product classification taxonomy).

Further, according to an embodiment, the version management system provides a taxonomy editing tool 456 that enables the editing of the domain vocabulary as well as the assertion of the subclass relations of the domain vocabulary terms as classes to the domain specific UPCO ontology when editing the older version using step 490.

Further, the version management system provides a taxonomy editing tool 458 that enables the editing of the atomic-level pattern AP1-AP12, which asserts new domain vocabulary classes as subclasses of existing product classification classes in the existing domain specific UPCO taxonomy 470. These changes can take the form of (a) creating new atomic-level patterns AP0-AP12 with the new domain vocabulary classes as part of adding a new product classification class or (b) modifying an existing product classification class complex expression. In this regard, the editing changes are backwards compatible, while modifying an existing product classification class is not.

Further, the version management system provides a tool 460 that enables the editing of the complex patterns consisting of the parent class and the appropriate atomic-level patterns to define the classification reasoning for that product classification class in the existing product classification taxonomy 470. The same evaluation for backwards compatibility occurs with these changes: new product classification classes are backwards compatible, while modifying the complex pattern for the product classification class prevents backwards compatibility.

Further, the version management system ontology, when integrated with the UPCO product classification ontology taxonomy can provide provenance detail for every class of the UPCO ontology and the domain-specific UPCO product classification ontology taxonomy with domain vocabulary classes. With this provenance metadata (in the form of version provenance classes identifying the nature of the change and its effect on backwards compatibility, as well as the dates and corresponding version codes for every version-managed class), the version management reasoning results corresponding to step 462 can enable validation testing of the updated existing UPCO taxonomy 470 such that it can be used as the new version 480, with knowledge of whether it is backwards compatible with the previous version 470.

Further, the version management system can provides all of the capabilities steps 456, 458, 460, and 462 in an integrated version management tool 464, which uses the version management ontology 466 when integrated with the UPCO ontology taxonomies 470 and 480.

Further, according to an embodiment, the reasoning engine 350 of FIG. 3 can execute domain-specialized ontology pattern equivalent axiom expressions 320, representing the specific product definition corresponding to a product definition text 325 contained in the taxonomic table of product definitions 335, in order to ensure that (i) the product definition is unique and not contained in other locations within this taxonomy or any other taxonomy and (ii) the product definition reasoning result is placed in the correct taxonomic position and is fully entailed as a subclass of the taxonomic parent product definition according to validation step 440 of FIG. 4A. In addition, if the reasoning taxonomic classification is not unique, and there are multiple partial entailments with one or more taxonomic product definitions, the system 300 can identify those product classification classes having one or more satisfied common atomic-level ontology expressions that have been asserted for an unknown product class. This can occur through a variety of methods: (a) a SPARQL query can be asserted to find these product classification classes with partial entailments of one or more atomic-level patterns or (b) a small class can be defined with a parent having the set of atomic-level patterns for that unknown product. The latter approach can enable the reasoning engine to find those product classification classes in which the complex pattern is inferred as a subclass of one or more product classification classes (indicating that there are more atomic-level patterns necessary to be asserted for that unknown product to be fully entailed by one of the product classification classes of which it is inferred to be a subclass of). These approaches can be provided automatically in a user interface to display the candidate partially-entailed product classification classes as well as the atomic-level patterns necessary for each to be fully entailed. The user can then evaluate the unknown product text description to determine which atomic-level pattern to assert to enable full entailment based on the appropriateness of the partially-entailed classification class.

Further, after the system 300 reads and parses an authoritative definition in the document 325, it can also determine what is missing from the atomic-level expressions and reasoning results in order to provide unambiguous, taxonomic-consistent, and disambiguating unique product definitions. In other cases, the reasoning results can be utilized to help author new definitions based on some evidence gathering or experimentation, or analysis of related background domain knowledge published in other sources. Further, the system 300 also supports consistency-checking as new definitions are added (or existing definitions are modified) by providing reasoning consistency results that ensure global uniqueness of product definitions across different taxonomies and within the same taxonomy, as illustrated in FIG. 4A using tool 440.

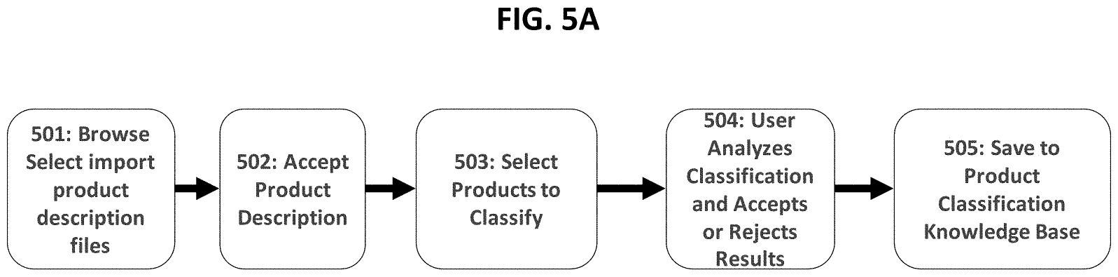

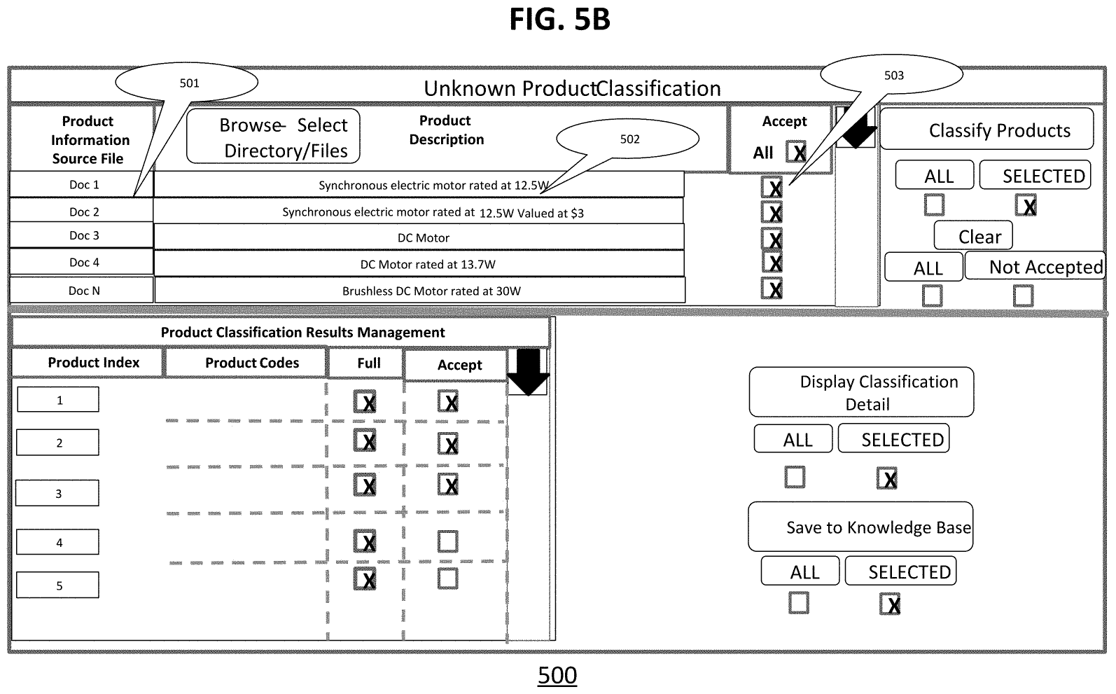

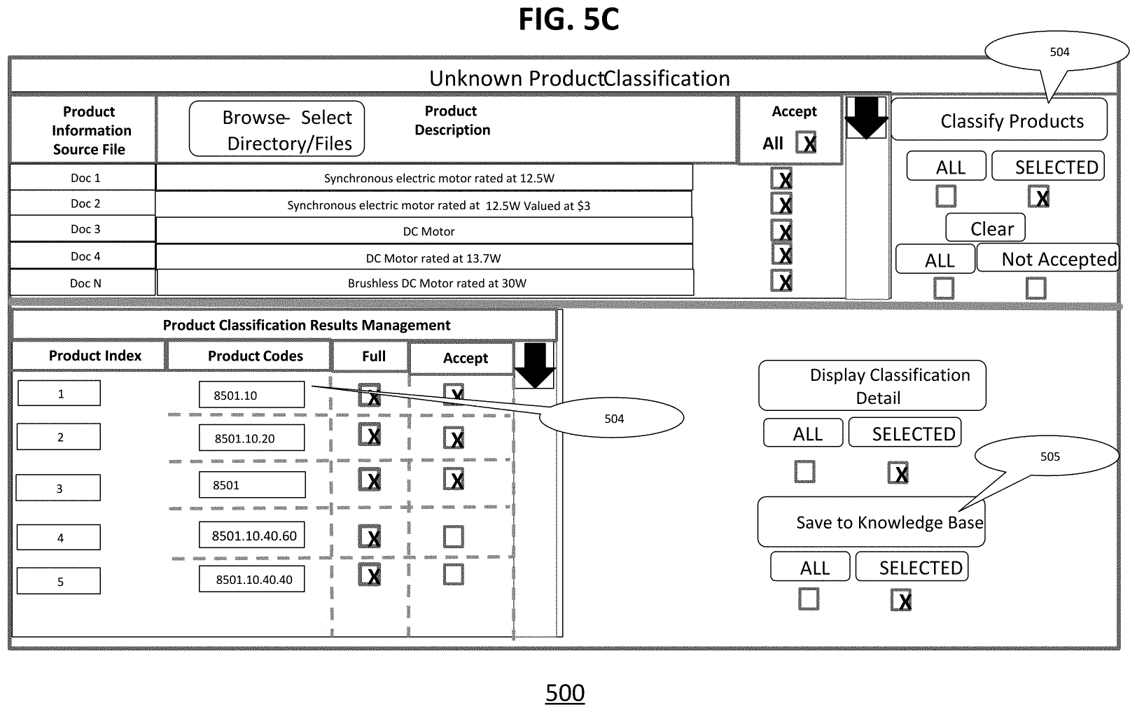

FIG. 5A illustrates a user interface 500 sequence process flow for classifying unknown products according to an exemplary embodiment of the invention. In particular, the figure illustrates steps 501, 502, 503, 504, and 505 that a user can follow to enable the system to classify multiple products. Each step progressively provides the user specific capabilities to accept, modify, or reject the inputs or outputs to the system. FIGS. 5B and 5C illustrate the informational and controls/commands available to the user at the interface for each step. For example, FIG. 5B illustrates the areas of the user interface that correspond to step 501, step 502, and step 503, while FIG. 5C illustrates the areas of the user interface that correspond to step 504 and 505. According to an embodiment, in step 501, the user can choose source files for acquiring production description information. Such source files can include product specification brochures, which are limited in size and have explicit information about the salient product characteristics for comparison purposes. After the selection, the system can automatically extract all of the relevant text related to the product characterization. In step 502, the user is provided with the option of editing the product description text box to only contain phrases describing the type of product and its characteristics. Further, in step 503, with the “Accept” box, the user is able to select which products to classify (e.g., by selecting the “Classify Products” button). According to an embodiment, the system classifies each product using the atomic-level expressions describing unknown product classification, and identifies those complete classification entailments to product classification definitional ontology-taxonomy. Further, as depicted in FIG. 5B, the user also has the option of clearing all of the selected product specification sources and information text (e.g., by selecting the “Clear” button). In step 504, the system reasoning engine performs the classification, where the results of the classification are presented in the user interface. In particular, the user interface displays the products with “Complete Entailment,” e.g., 8501.10, 8501.10.20, 8501, 8501.10.40.60, 8501.10.40.40. Further, as depicted in the figure, the user is provided with an ability to accept the results for each of the classified products. In addition, the user can also select “Open Detailed Product Classification Windows” for selected products, which displays additional detailed information (e.g., entailed atomic-level expressions, partial entailments, etc.) and controls for the product. Then, in step 505, the user is provided with the ability to store all or selected product classification results in a knowledge base (e.g., by selecting the “Save to Knowledge Base” button). This knowledge base can store the results using the W3C standard OWL/RDF language enabling integration in an enterprise for applications, web services, and other semantic web-linked data, knowledge graphs, and semantic web ontologies. Further, as depicted in the figure, the user can also display the detail rational for any product classification (e.g., by selecting the “Display Classification Detail” button).

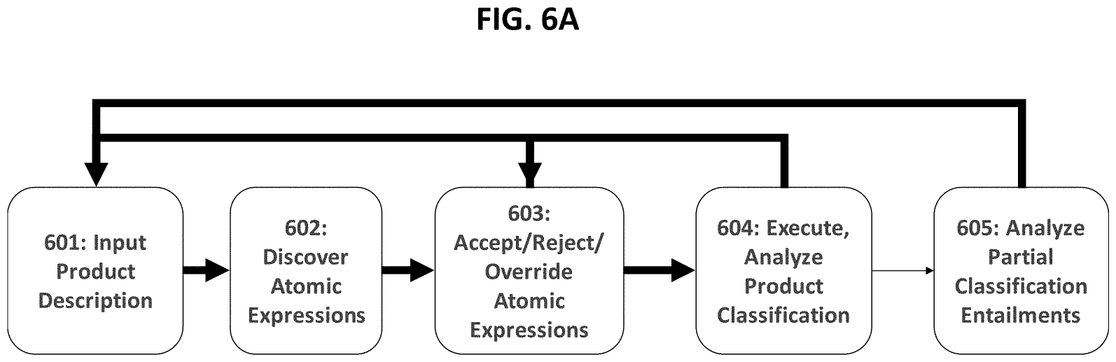

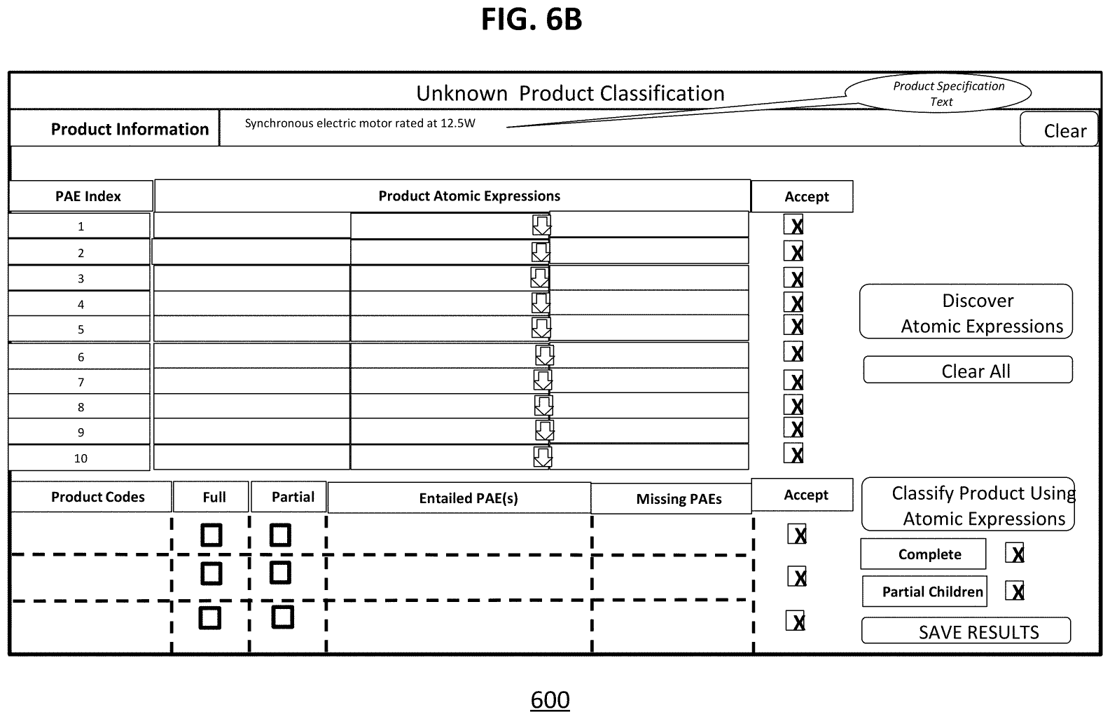

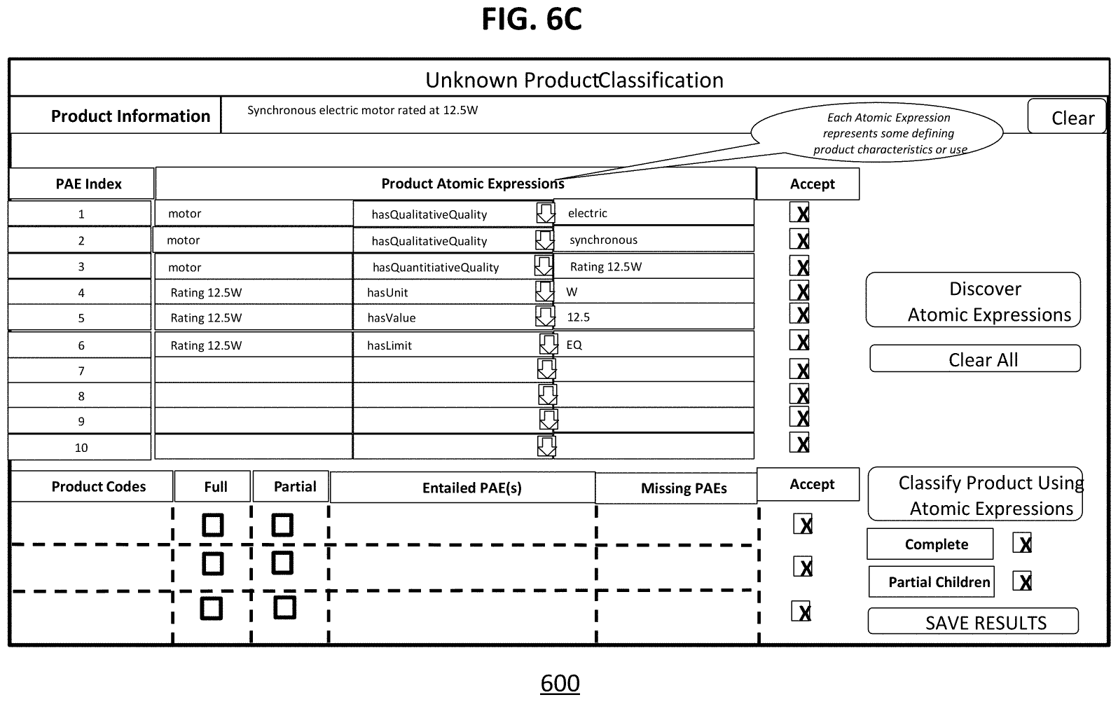

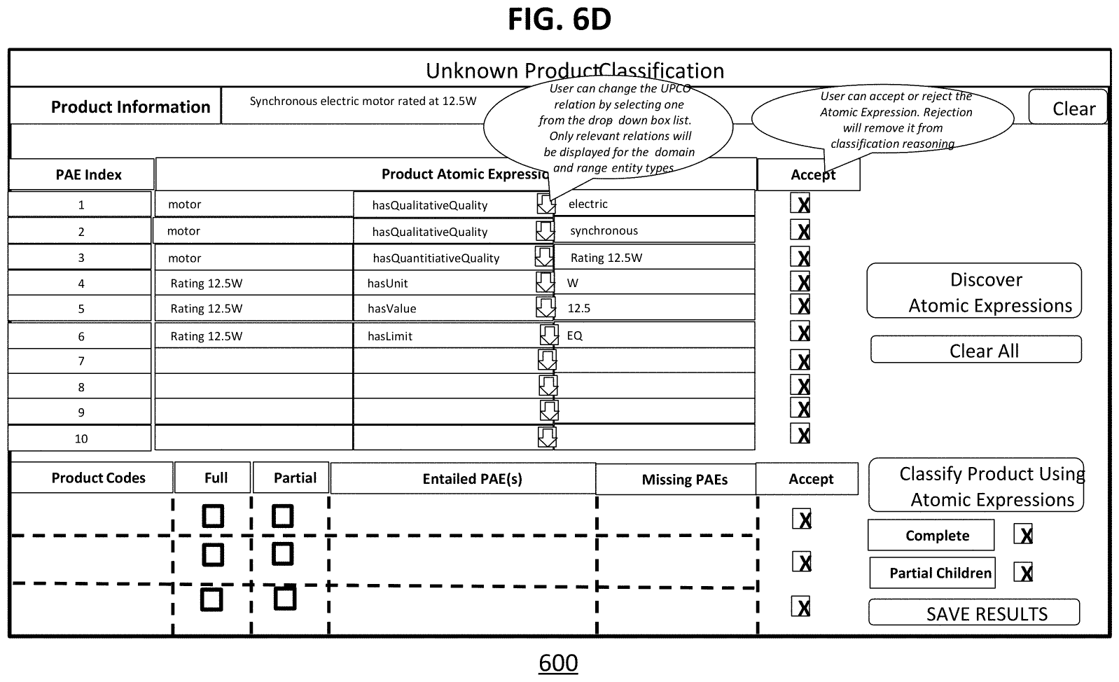

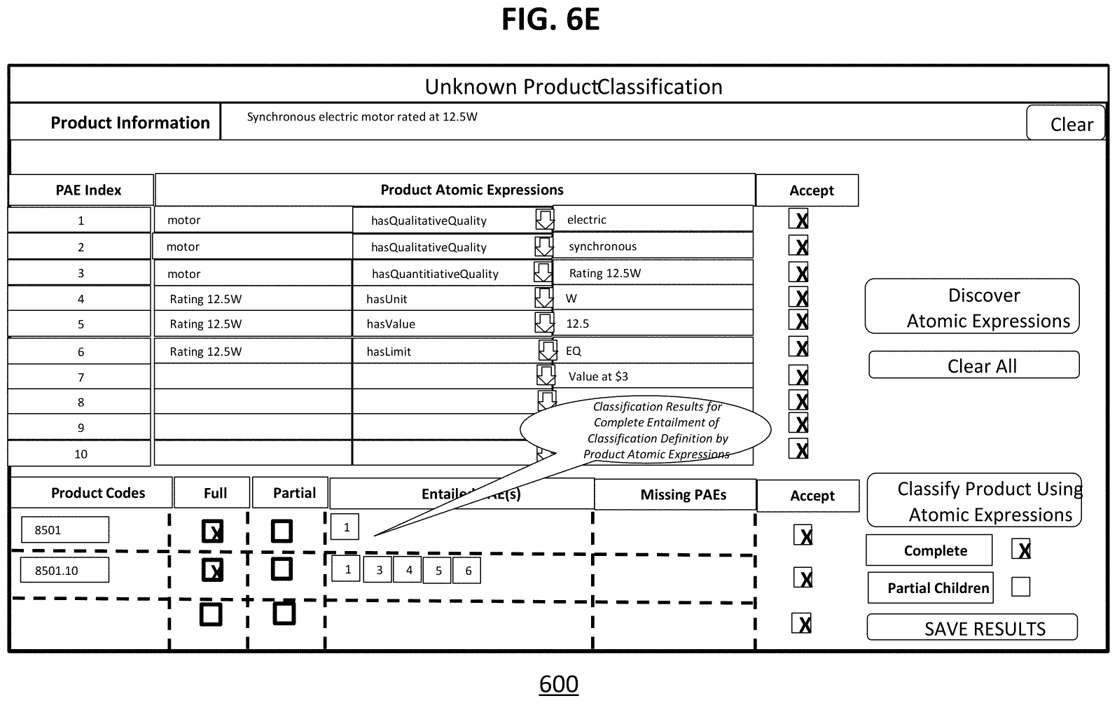

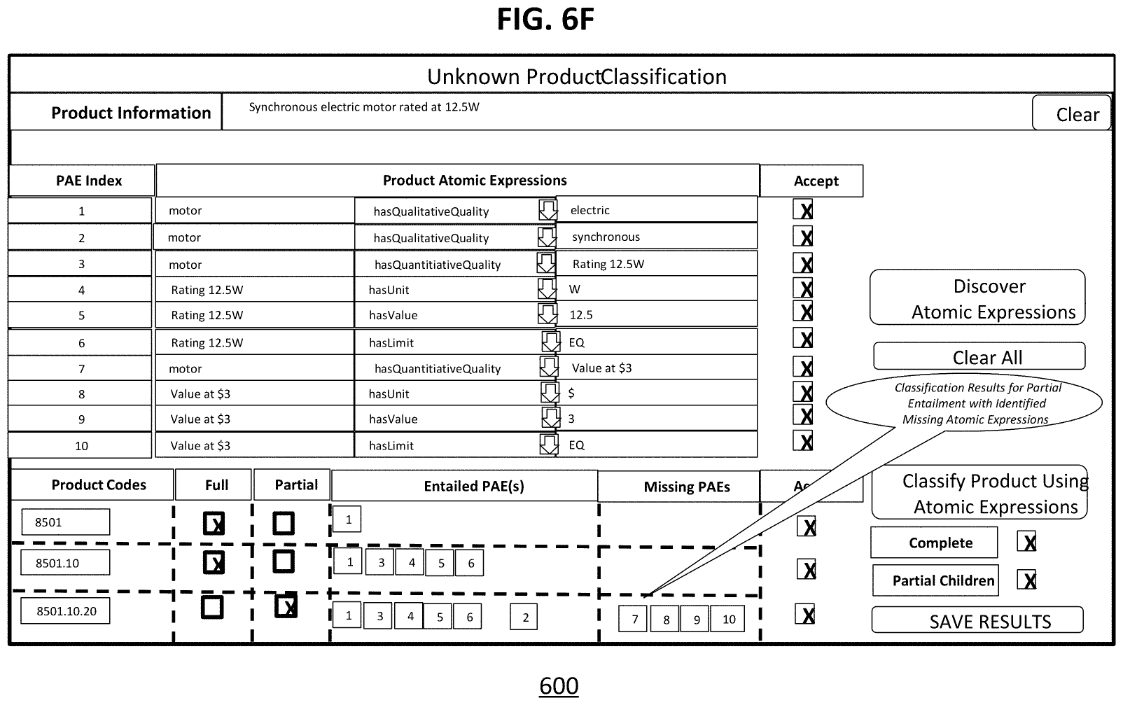

FIG. 6A illustrates a user interface 600 sequence process flow for classifying unknown products according to an exemplary embodiment of the invention. In particular, the figure illustrates steps 601, 602, 603, 604, and 605 that are used to enable the classification.

FIG. 6B illustrates the first step of the sequence process flow of FIG. 6A according to an exemplary embodiment of the invention. As depicted in the figure, in step 601, the user can input the product description, e.g., “Synchronous electric motor rated at 12.5 W.” In another embodiment, the product description can be extracted from an electronic source or document. According to an embodiment, only minimal product specification-type information is necessary for classification.

FIG. 6C illustrates the second step of the sequence process flow of FIG. 6A according to an exemplary embodiment of the invention. In step 602, the user can select the “Discover Atomic Expressions” button in order to determine the atomic-level expressions associated with the product description text. According to an embodiment, the system determines the associated atomic-level expression by (i) asserting the description terms to the UPCO classes and (ii) matching the terms and their classifications to the UPCO atomic-level relationships. The system then displays the discovered atomic-level expressions as depicted in the figure. Each atomic-level expression represents some defining characteristic or use. Further, each atomic-level expression includes product terms for the domain and range values of a discovered atomic-level expression relation.

FIG. 6D illustrates the third step of the sequence process flow of FIG. 6A according to an exemplary embodiment of the invention. In step 603, the user is provided with the ability to accept each atomic-level expression or override it with another selection of the atomic-level relation. The accepted atomic-level expressions will form the basis for product classification in the next step. Further, as depicted in the figure, the user can change the UPCO relation by selecting one from the drop down box list. According to an embodiment, only relevant relations will be displayed for the domain and range entity types. Further, the user is also able to clear all of the atomic-level expressions (e.g., by selecting the “Clear All” button) and input (or edit) the product description, thereby going back to step 601.

FIG. 6E illustrates the fourth step of the sequence process flow of FIG. 6A according to an exemplary embodiment of the invention. In step 604, the user can classify the unknown product by selecting the “Classify Product Using Atomic Expressions” button in the interface. The system responds to the classification command and classifies the product using the selected set of atomic-level expressions to reason whether a particular product classification definition is entailed completely by this set of product atomic-level expressions. For example, the system may query a knowledge base for product codes that are completely entailed. The system then displays the full hierarchical product classification codes as well as the corresponding atomic-level expressions entailed at each level. Further, as depicted in the figure, the user also has the ability to accept or reject the classifications, or start over again at step 603 e.g., by modifying the atomic-level expressions.

FIG. 6F illustrates the fifth step of the sequence process flow of FIG. 6A according to an exemplary embodiment of the invention. In step 605, the user can also select to display any partial entailments and corresponding missing atomic-level expressions by selecting the “Partial Children” check box. In response, the system can query a knowledge base to discover children classifications of complete classifications that have partial entailments, and also displays the missing atomic-level expressions. In this regard, if the user wants complete entailment of the children, then the user must modify the description in step 601 in order to include relevant additional information from the missing atomic-level expressions. Further, the user can store any of the selected classification results in a product classification knowledge base for further use at an enterprise level by applications, services, etc.

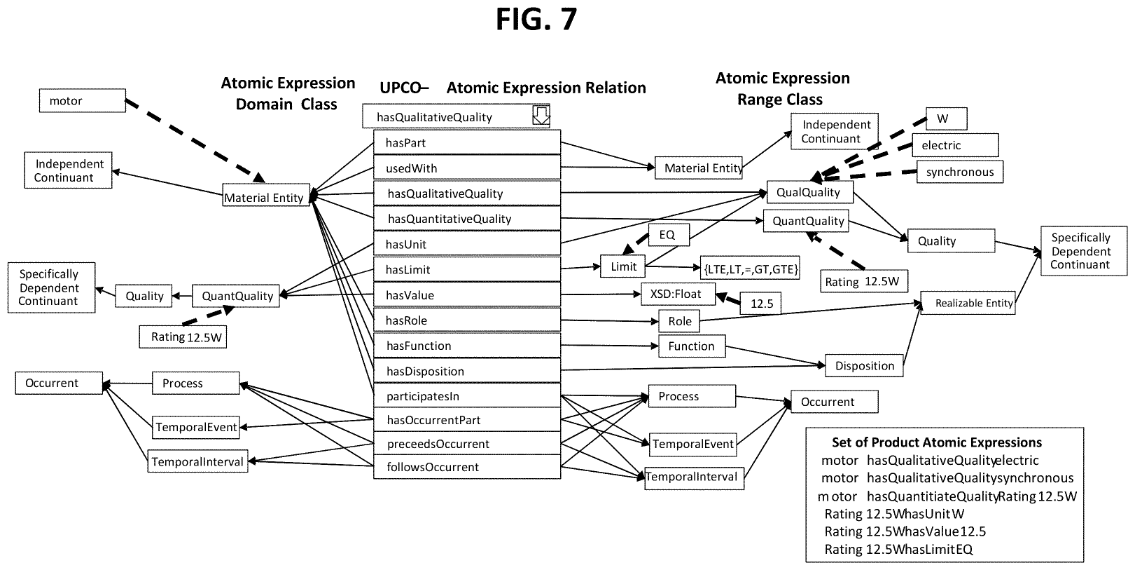

FIG. 7 illustrates an exemplary set of atomic-level expressions and their respective domain and range UPCO classes for each UPCO relation. According to an embodiment, when the system reasons about product classification, it has a predefined product classification ontology-taxonomy that has complex definition expression comprised of a subset of the exemplary atomic-level expressions formed in a model-theoretic semantic logical expression that enables ontology reasoning. A product specification can be transformed into a set of atomic-level expressions, which represent the nature and use of the product in some context, using the vocabulary terms of the product specification, where these terms are aligned/classified as a kind of UPCO class, which are then associated with a domain or range of a specific atomic-level expression.

The system then reasons whether the product specification atomic-level expressions satisfy/entail the product classification definition set of atomic-level expressions. If the product classification definition is satisfied than this product classification definition is identified by the reasoning system. Further, since the product classification is based on the set of atomic-level expressions for each product classification definition, the system can also display those classifications that have only a partial subset of atomic-level expressions satisfied.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The system described above can be implemented with graph and web servers and other computing devices in various configurations, such as cloud services. The various servers and computing devices may use software to execute programs to execute the methods described above. Various embodiments of the invention also relate to the software or computer readable medium containing program instructions for executing the above-described methods.

Although the foregoing examples show the various embodiments of the invention in one physical configuration; it is to be appreciated that the various components may be located at distant portions of a distributed network, such as a local area network, a wide area network, a telecommunications network, an intranet and/or the Internet, or a cloud service. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Communications networks connect the various computing devices described above and may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The communications networks that connect the various computing devices described above may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a GPS link, a cellular digital packet data (CDPD) link, a Research in Motion, Limited (RIM) duplex paging type device, a Bluetooth radio link, or an IEEE 802.11-based radio frequency link. Communications networks may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, the communication networks may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication networks may comprise a Personal Branch Exchange (PBX), which may further connect to the PSTN.

Although examples of servers and personal computing devices are described above, exemplary embodiments of the invention may utilize other types of communication devices whereby a user may interact with a network that transmits and delivers data and information used by the various systems and methods described herein. The personal computing devices may include desktop computers, laptop computers, tablet computers, smart phones, and other mobile computing devices, for example. The servers and personal computing devices may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The personal computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The personal computing devices may also include a network-enabled appliance or another TCP/IP client or other device. The personal computing devices may include various connections such as a cell phone connection, WiFi connection, Bluetooth connection, satellite network connection, and/or near field communication (NFC) connection, for example.

The servers and personal computing devices described above may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software, firmware, hardware, or a combination of the foregoing.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers and personal computing devices described above may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript and others. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A computer-implemented system for creating a product classification taxonomy for an existing product taxonomy using a universal product classification ontology, the system comprising:
at least one processing module comprising at least one computer processor and at least one electronic memory, wherein the at least one processing module is programmed to create the product classification taxonomy by:
asserting a plurality of subclasses for a plurality of entity terms in the existing product taxonomy as subclasses of classes defined in the universal product classification ontology;
generating semantic relationships between the plurality of entity terms asserted as subclasses using predefined semantic relationships from the universal product classification ontology;
generating a combination of the semantic relationships to create a product classification definition in the product classification taxonomy based on the universal product classification ontology for at least one definition associated with the plurality of entity terms in the existing product taxonomy; and
a reasoning engine comprising a computer processor that is programmed to validate the product classification definition.

2. The system of claim 1, wherein the at least one processing module includes a first processing module, a second processing module, and a third processing module, wherein the first processing module is programmed to: (i) extract the plurality of entity terms from the existing product taxonomy, (ii) populate a domain vocabulary ontology associated with the universal product classification ontology with the extracted plurality of entity terms, and (iii) assert class and subclass relations for the domain vocabulary ontology terms, wherein the class and subclass relations are associated with corresponding universal product classification ontology classes.

3. The system of claim 2, wherein the second processing module is programmed to assert the semantic relationships between the asserted class and subclass relations; and
the third processing module is programmed to (i) combine the asserted semantic relationships and (ii) create the product classification definition based on the combined semantic relationships.

4. The system of claim 1, wherein the universal product classification ontology classes include at least one of: a product class, a qualitative quality class, a quantitative quality class, a function, and a process class.

5. The system of claim 1, wherein the semantic relationships are based on the corresponding universal product classification ontology classes and their specialized subclasses, and a set of binary relations.

6. The system of claim 1, wherein the reasoning engine is compliant with W3C OWL2 Web Ontology Language.

7. The system of claim 1, wherein the reasoning engine validates the created product classification taxonomy by testing the created product classification taxonomy's classification definitions with at least one test classification pattern.

8. The system of claim 1, wherein the at least one processing module is configured to create the product classification taxonomy and another product classification taxonomy concurrently.

9. A computer-implemented system for creating a new product classification taxonomy based on an existing product classification taxonomy using a universal product classification ontology, the system comprising:
at least one computer processor and an electronic memory, wherein the at least one computer processor is programmed to create the new product classification taxonomy by:
determining which changes were made to the existing product classification taxonomy;
editing domain vocabulary terms associated with the existing product classification taxonomy corresponding to the changes;
editing at least one of an asserted class relation and an asserted subclass relation for at least one universal product classification ontology class in the existing product classification taxonomy based on the changes;
editing at least one asserted semantic relationship in the existing product classification taxonomy based on the changes; and
editing at least one combined semantic relationship based on the changes; and
wherein the at least one computer processor is further programmed to validate the created new product classification taxonomy.

10. The system of claim 9, wherein the at least one universal product classification ontology class includes at least one of: a product class, a qualitative quality class, a quantitative quality class, a function, and a process class.

11. The system of claim 9, wherein the semantic relationships are based on the at least one universal product classification ontology class and its specialized subclasses, and a set of binary relations.

12. The system of claim 9, wherein the at least one computer processor is further programmed to validate the created by performing a backwards compatibility check with the existing product classification taxonomy.

13. A computer-implemented method for classifying an unknown product using a universal product classification ontology, the method comprising:
receiving, with a user interface, product information text associated with the unknown product;
determining, with a computer processor, semantic relationship expressions associated with the product information text using the universal product classification ontology;
classifying, with the computer processor, the unknown product with at least one product classification definition based on the determined semantic relationship expressions; and
displaying, with the user interface, at least one product code or other classification identifier associated with the at least one product classification definition.

14. The method of claim 13, wherein the semantic relationship expressions are based on at least one universal product classification ontology class and a set of binary relations.

15. The method of claim 13, wherein the determining includes:
extracting, with the processor, terms in the product information text;
asserting, with the processor, the terms to at least one universal product classification ontology class; and
matching, with the processor, the terms and their corresponding universal product classification ontology classes to semantic relationship expressions in the universal product classification ontology.

16. The method of claim 15, wherein the at least one universal product classification ontology class includes at least one of: a product class, a qualitative quality class, a quantitative quality class, a function, and a process class.

17. The method of claim 13, wherein the classifying includes querying, with the processor, a knowledge base for product classification definitions that are completely entailed by the determined semantic relationship expressions associated with the product information text.

18. The method of claim 13, further comprising:
querying, with the processor, a knowledge base for product classification definitions that are partially entailed by the determined semantic relationship expressions associated with the product information text; and
displaying, with the user interface, (i) at least one product code or other classification identifier associated with the partially-entailed product classification definitions and (ii) any missing semantic relationship expressions associated with the partially-entailed classification definitions.

19. The method of claim 13, further comprising:
storing the at least one product code or other classification identifier in a knowledge database.
